(19) United States
(12) Patent Application Publication
(10) Pub. No.: US 2008/0311911 A1
(43) Pub. Date: Dec. 18, 2008

(54) Handover trigger for an inter-access-gateway interface

(75) Inventors: Rajeev Koodli, Sunnyvale, CA (US); Basavaraj Patil, Coppell, TX (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 11/812,259

(22) Filed: Jun. 15, 2007

(51) Int. Cl. H04Q 7/20

(52) U.S. Cl. 455/436

(57) ABSTRACT

An apparatus and method are provided in which multiple options are configured to deliver a base-station ID (BSID), which acts as a trigger for an initiation of a handover at an access gateway level. The handover triggers may be based on a proactive handover between at least one mobile station and a gateway and base station in a serving and target networks or on a reactive handover in which the at least one mobile station does not perform any handover preparation prior to the handover. In addition, the handover trigger may be based on a network initiating and controlling the handover.

### BACKGROUND OF THE INVENTION

1. Field of the Invention

The present invention relates to an apparatus and method of enabling handover at IP layer between networks of different access technologies, in particular, the present invention provides an apparatus and method including multiple options for a handover trigger at an IP layer between networks of different access technologies to be delivered to an access gateway in an access network.

2. Description of the Related Art

A WiMAX system lends itself as a lightweight Internet access technology. It is built on top of 802.16 standard family MAC+PHY (Medium Access Control+Physical layer) standard from IEEE (certified by WiMAX). The system standard (higher layers and network) is standardized and certified by WiMAX Forum. An Internet Protocol layer (IP layer) provides a common interface between different transport-layer protocols and different link-layer devices.

An inter-access-gateway interface between gateways of access networks that are of different technologies may enable seamless session continuity by virtue of optimizing a handover process at the IP layer. In order to initiate the context transfer and forwarding of packets between the gateways when a mobile station (MS) performs a handover, although not currently available, a trigger is needed at the serving gateway. Options are needed on how the trigger may be delivered to a control plane function or an access gateway in an access network.

An apparatus and method are needed so that when a mobile station in an active session does a handover between access networks of different technologies, the performance of the handover can be significantly improved by optimizations at the IP layer. Triggers from either a mobile station or radio-access-network elements (for instance, a base station or a mobility management entity (MME)) could cause a serving access gateway to trigger context transfer and packet forwarding to a target gateway.

An apparatus and method are needed for an initiation or trigger of a handover that would include an identifier of either a target base station or a serving base station.

### SUMMARY OF THE INVENTION

In accordance with an embodiment of the present invention, there is provided a network device, including a scanning unit configured to scan and obtain an identifier associated with a target base station in a target network while receiving services from a serving network, and a transmitting unit configured to transmit the identifier as a parameter in a handover request message to a serving base station in the serving network, wherein the handover request message is used as a trigger for initiating a handover of the network device from the serving network to the target network.

In accordance with an embodiment of the present invention, there is provided a network device, including scanning means for scanning and obtaining an identifier associated with a target base station in a target network while receiving services from a serving network, and transmitting means for transmitting the identifier as a parameter in a handover request message to a serving base station in the serving network, wherein the handover request message is used as a trigger for initiating a handover of the network device from the serving network to the target network.

In accordance with an embodiment of the present invention, there is provided a method, including obtaining an identifier associated with a target base station in a target network while receiving services from a serving network, transmitting the identifier as a parameter in a handover request message to a serving base station in the serving network, and using the handover request message as a trigger for initiating a handover of the network device from the serving network to the target network.

In accordance with an embodiment of the present invention, there is provided an apparatus, including a control plane entity in a serving network configured to receive a layer 2 message as a control plane message from a network device indicating that the network device is to perform a handover to a target base station in a target network. The layer 2 message includes an identifier associated with the target base station in the target network, and configured to process the layer 2 message as a trigger to initiate the handover for the network device from the serving network to the target network.

In accordance with an embodiment of the present invention, there is provided a network device, including a scanning unit configured to scan and obtain an identifier associated with a target base station in a target network, an identifying unit configured to identify a control plane entity of a serving gateway in a serving network, and a transmitting unit configured to transmit a layer 2 message as a control plane message to the control plane entity indicating that the network device is performing a handover to the target base station in the target network. The layer 2 message includes the identifier of the target base station and is processed as a trigger to initiate the handover for the network device from the serving network to the target network.

In accordance with an embodiment of the present invention, there is provided a network device, including obtaining means for obtaining an identifier associated with a target base station in a target network, identifying means for identifying a control plane entity of a serving gateway in a serving network, and transmitting means for transmitting a layer 2 message as a control plane message to the control plane entity indicating that the network device is performing a handover to the target base station in the target network. The layer 2 message includes the identifier of the target base station and is processed as a trigger to initiate the handover for the network device from the serving network to the target network.

In accordance with an embodiment of the present invention, there is provided a method, including obtaining an identifier associated with a target base station in a target network, identifying a control plane entity of a serving gateway in a serving network for a network device to communicate, transmitting a layer 2 message as a control plane message from the network device to the control plane entity indicating that the network device is performing a handover to the target base station in the target network. The layer 2 message includes the identifier of the target base station. The method also includes processing the layer 2 message as a trigger to initiate the handover for the network device from the serving network to the target network.

In accordance with an embodiment of the present invention, there is provided a network device, including a storing unit configured to store an identifier of a serving base station in a serving network, and a transmitting unit configured to transmit a handover request to a target gateway via a target base station in a target network and configured to transmit the identifier of the serving base station to the target gateway. The target gateway is configured to map the identifier of the serving base station provided by the network device to an address of a serving gateway in the serving network, and transmit the handover request to the serving gateway including an address of the target gateway to trigger the serving gateway for context transfer and to forward bearer packets associated with the network device to the target gateway.

In accordance with an embodiment of the present invention, there is provided a network device, including storing means for storing an identifier of a serving base station in a serving network, and transmitting means for transmitting a handover request to a target gateway via a target base station in a target network and configured to transmit the identifier of the serving base station to the target gateway. The target gateway maps the identifier of the serving base station provided by the network device to an address of a serving gateway in the serving network and transmits the handover request to the serving gateway including an address of the target gateway to trigger the serving gateway for context transfer and to forward bearer packets associated with the network device to the target gateway.

In accordance with an embodiment of the present invention, there is provided a method, including storing an identifier of a serving base station in a serving network, transmitting a handover request to a target gateway via a target base station in a target network and configured to transmit the identifier of the serving base station to the target gateway, mapping the identifier of the serving base station provided by a network device to an address of a serving gateway in the serving network, and transmitting the handover request to the serving gateway including an address of the target gateway to trigger the serving gateway for context transfer and to forward bearer packets associated with the network device to the target gateway.

In accordance with an embodiment of the present invention, there is provided a network device, including a storing unit configured to store an identifier and corresponding address of a control plane entity in a serving network, a transmitting unit configured to transmit a control plane message to a target gateway via a target base station in a target network, and configured to transmit the identifier and corresponding address of the control plane entity to the target gateway. The target gateway is configured to transmit the control plane message indicating handover to the control plane entity including an address of the target gateway to trigger the control plane entity for context transfer and to forward bearer packets associated with the network device to the target gateway.

In accordance with an embodiment of the present invention, there is provided a method, including storing an identifier and corresponding address in a network device of a control plane entity in a serving network, transmitting a control plane message from the network device to a target gateway via a target base station in a target network, transmitting the identifier and corresponding address of the control plane entity from the network device to the target gateway, and transmitting the control plane message indicating handover from the target gateway to the control plane entity including an address of the target gateway to trigger the control plane entity for context transfer and to forward bearer packets associated with the network device to the target gateway.

In accordance with an embodiment of the present invention, there is provided an apparatus, including a serving base station in a serving network configured to comprise a list of identifiers of neighboring target base stations in target networks, configured to send a handover command message to a network device including an identifier corresponding to a target base station in a target network to which the network device is to handover, and configured to send a handover trigger message to a serving gateway providing the identifier corresponding to the target base station to which the network device is to handover. The serving gateway is configured to map an address of a target gateway in the target network based on the identifier corresponding to the target base station, the network device is configured to receive the handover command message and perform the handover to the target base station associated with the identifier, and the serving gateway is configured to context transfer and to forward bearer packets associated with the network device to the target gateway.

In accordance with an embodiment of the present invention, there is provided an apparatus, including serving base station means, including a list of identifiers of neighboring target base stations in target networks, for sending a handover command message to a network device including an identifier corresponding to a target base station in a target network to which the network device is to handover, and for sending a handover trigger message to a serving gateway providing the identifier corresponding to the target base station to which the network device is to handover. The serving gateway maps an address of a target gateway in the target network based on the identifier corresponding to the target base station, the network device receives the handover command message and perform the handover to the target base station associated with the identifier, and the serving gateway context transfers and forwards bearer packets associated with the network device to the target gateway.

In accordance with an embodiment of the present invention, there is provided a method, including configuring a serving base station in a serving network to include a list of identifiers of neighboring target base stations in target networks, sending, through the serving base station, a handover command message to a network device including an identifier corresponding to a target base station in a target network to which the network device is to handover, sending, through the serving base station, a handover trigger message to a serving gateway providing the identifier corresponding to the target base station to which the network device is to handover, and configuring the serving gateway to map an address of a target gateway in the target network based on the identifier corresponding to the target base station. The method also includes receiving the handover command message at the network device, performing the handover of the network device to the target base station associated with the identifier, and performing at the serving gateway context transfer and forwarding of bearer packets associated with the network device to the target gateway.

In accordance with an embodiment of the present invention, there is provided a network device configured to conduct a data session with a serving network element in a serving network. The network device includes a transmitting unit configured to transmit a hold message to the serving network element requesting the serving network element to hold the data session and buffer data packets for a predetermined period of time, configured to search for a target network element and obtain an identifier of the target network element, and configured to transmit a transmit message to the serving network element requesting to continue the data session and forward the buffered data packets, wherein the network device performs multiple transmissions of the hold message and transmit message in a time-division multiplexed manner to avoid a transmission delay.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 illustrates a system having an interface to provide handovers between gateways in networks, in accordance with an embodiment of the present invention.

FIG. 2 illustrates a configuration of a network device, in accordance with an embodiment of the present invention.

FIG. 3 illustrates a proactive handover method between a serving gateway and a target gateway, in accordance with an embodiment of the present invention.

FIG. 4 illustrates an alternative proactive handover method between the serving gateway and the target gateway, in accordance with an embodiment of the present invention.

FIGS. 5A and 5B illustrate a reactive handover method between the serving gateway and the target gateway, in accordance with an embodiment of the present invention.

FIG. 6 illustrates a handover method initiated by a network between the serving gateway and the target gateway, in accordance with an embodiment of the present invention.

### DETAILED DESCRIPTION OF THE PREFERRED EMBODIMENTS

Reference will now be made in detail to preferred embodiments of the present invention, examples of which are illustrated in the accompanying drawings. The embodiments of the present invention described below provide an apparatus and method in which multiple options are configured to deliver a base-station ID (BSID), which acts as a trigger for an initiation of a handover at an access gateway level. The handover triggers may be based on a proactive handover between at least one mobile station and a gateway and a base station in serving and target networks or on a reactive handover in which the at least one mobile station does not perform any handover preparation prior to the handover. In addition, the handover trigger may be based on a network initiating and controlling the handover.

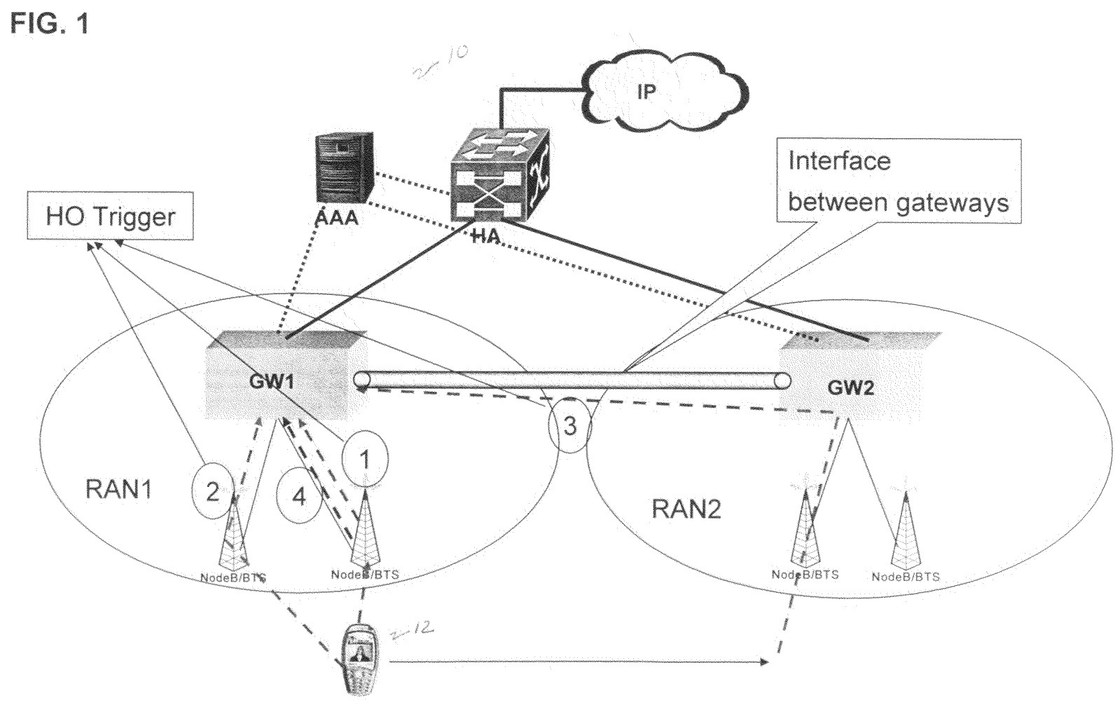

FIG. 1 illustrates a system related to mobility and seamless session continuity in an Internet protocol (IP) based networks. Mobile IP (Request for Comments (RFC) 3344 and RFC 3775) is a protocol specified by Internet Engineering Task Force (IETF) which is the basis for IP mobility used in many network architectures and technologies such as code division multiple access (CDMA2000), evolution to data optimized (EV-DO), worldwide interoperability for microwave access (WiMAX), and long term evolution (LTE). Fast handovers with Mobile IP is also specified in the IETF (RFC 4068 and draft-ietf-mip4-fmipv4).

In accordance with some embodiments of the present invention, the configuration described in FIG. 1 is based on the concepts of IP mobility and fast handovers in the context of mobile networks which are packet based. The mobility system 10 includes a common core network providing an inter-working operation to the heterogeneous wireless network systems so that the respective wireless network systems can access each other. The common core network includes a home agent (HA), and an authentication, authorization, accounting (AAA) unit. The HA is an imaginary router that maintains information on a current location of a subscriber in a mobile IP environment. The AAA unit in the common core network performs authentication and security operations on users when the inter-working operation is performed in the respective heterogeneous wireless network systems or between the respective heterogeneous wireless network systems.

A mobile station (MS) 12 may be configured to communicate with a serving radio access network (RAN1) via a wireless connection. This wireless connection may be at any suitable frequency such as for example a radio frequency. The RAN1 generally includes at least one serving base station entity (sometimes referred to as node B). The term serving base station is used and covers any suitable entity including. The RAN1 also includes a serving gateway (GW1) or a control plane entity. Some of the many functions of the serving gateway GW1 are to detect new mobile stations in its service area, handle the process of registering the new mobile stations, send/receive data packets to/from the mobile stations, keep a record of the location of the mobile stations inside of its service area, and provide communication/data transfer support for a handover of the mobile stations to other networks. In some configurations, a control function is provided separately from the serving base station and a single serving gateway GW1 may control a number of serving base stations. In other embodiments of the present invention, each serving base station may incorporate part of the control function. The RAN1 is configured to communicate with a control plane entity or the serving gateway GW1 and the serving base station.

The system 10 also provides a target radio access network (RAN2), which generally includes at least one target base station entity (also referred to as node B). The term target base station may be used and may cover any suitable entity. The RAN2 also includes a target gateway (GW2). Some of the many functions of the target gateway GW2 are to detect new mobile stations in its service area, and provide communication/data transfer support for the handover of the mobile stations. In some configurations, a control function is provided separately from the target base station and a single target gateway GW2 may control a number of target base stations. In other embodiments of the present invention, each target base station may incorporate part of the control function. The RAN2 may be configured to communicate with a control plane entity or the target gateway GW2 and the target base station.

In one embodiment of the present invention, an inter-access-gateway interface between the serving gateway GW1 and the target gateway GW2 of the serving and target networks RAN1 and RAN2, respectively, may be of different technologies and may enable seamless session continuity by virtue of optimizing the handover process at the IP layer. The different technologies may include, but are not limited to, evolution to data optimized (EV-DO) (packet data serving node), worldwide interoperability for microwave access (WiMAX) (abstract syntax notation gateway), long term evolution (LTE) (mobility management entity/system architecture evolution gateway), third generation partnership project (3GPP), 3GPP2, or internet engineering task force (IETF).

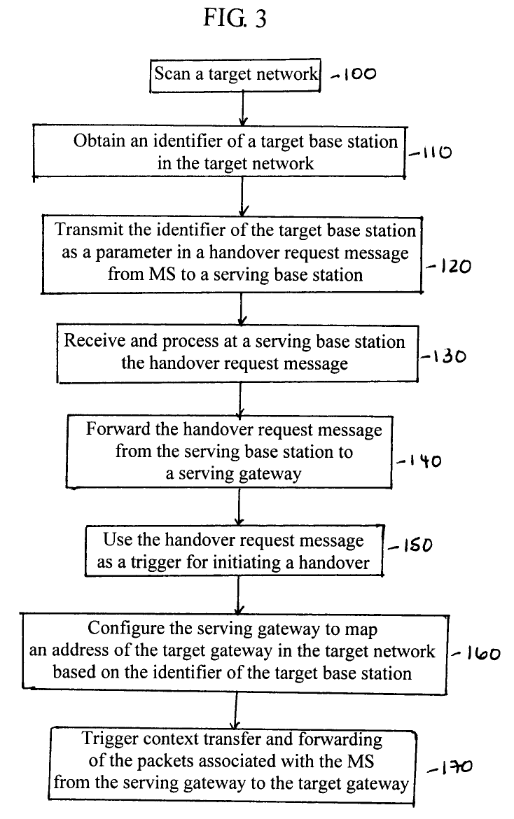

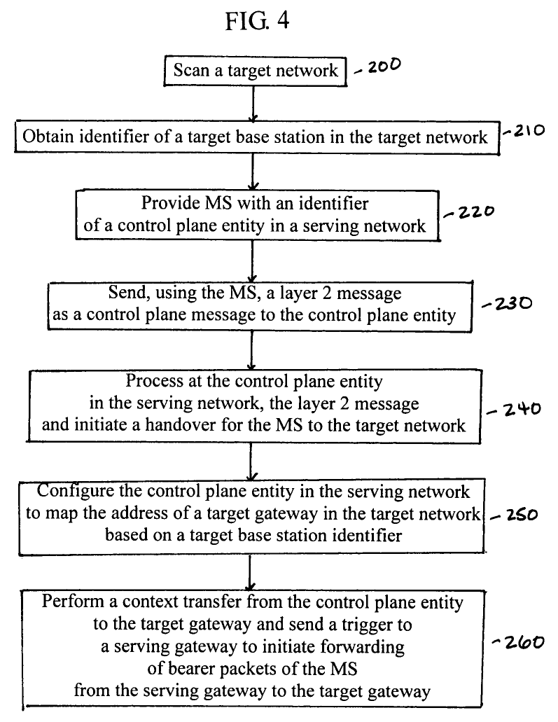

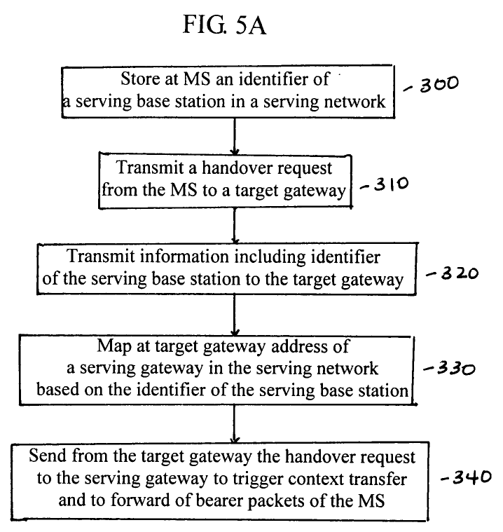

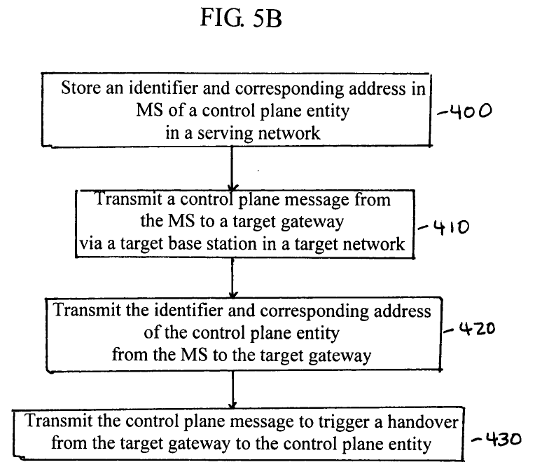

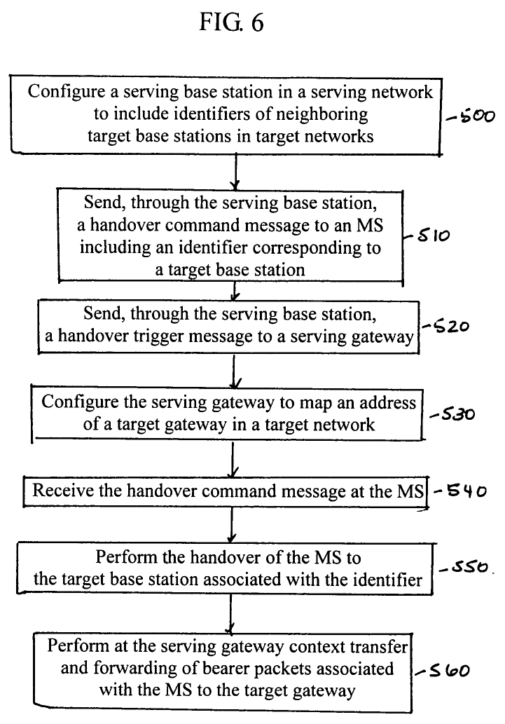

Reference numbers 1, 2, 3, and 4 illustrated in FIG. 1 refer to handover procedures to be executed between the mobile station 12, the serving gateway GW1 of the serving network RAN1 and the target gateway GW2 of the target network RAN2, which are described in detailed in FIGS. 3 to 6. For instance, reference number 1 shows a path a proactive handover procedure illustrated and described in FIG. 3, reference number 2 shows a path of another proactive handover procedure illustrated and described with respect to FIG. 4, reference number 3 shows a path of a reactive handover procedure illustrated and described with respect to FIGS. 5A and 5B, and reference number 4 shows a path of a network initiated handover procedure illustrated and described with respect to FIG. 6.

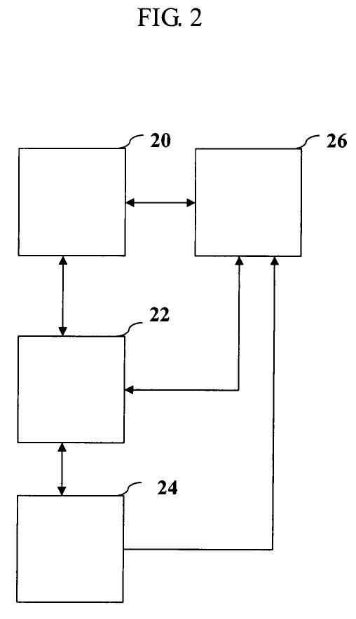

FIG. 2 illustrates a configuration of the MS, in accordance with an embodiment of the present invention. In order to perform the handover procedures illustrated in FIGS. 3 to 6, the MS 12 includes, at least, a scanning unit 20, an identifying unit 22, a storing unit 24, and a transmitting unit 26.

In accordance with an embodiment of the present invention, a proactive handover between the MS 12, the serving gateway GW1, and the target gateway GW2 include the scanning unit 20 configured to scan and obtain an identifier associated with a target base station in a target network while receiving services from a serving network. The transmitting unit 26 is configured to transmit the identifier as a parameter in a handover request message to a serving base station in the serving network, wherein the handover request message is used as a trigger for initiating a handover of the MS 12 from the serving network to the target network.

In accordance with an embodiment of the present invention, another proactive handover between the MS 12, the serving gateway GW1, and the target gateway GW2 include the scanning unit 20 configured to scan and obtain an identifier associated with a target base station in a target network. The identifying unit 22 is configured to identify a control plane entity of the serving gateway GW1 in the serving network RAN1. The transmitting unit 26 is configured to transmit a layer 2 message as a control plane message to the control plane entity indicating that the MS 12 is performing a handover to the target base station in the target network. The layer 2 message includes the identifier of the target base station and is processed as a trigger to initiate the handover for the MS 12 from the serving network to the target network.

In accordance with an embodiment of the present invention, a reactive handover between the MS 12, the serving gateway GW1, and the target gateway GW2 includes the storing unit 24 configured to store an identifier of the serving base station in the serving network RAN1. The transmitting unit 26 is configured to transmit a handover request to the target gateway GW2 via the target base station in the target network RAN2 and configured to transmit the identifier of the serving base station to the target gateway GW2. The target gateway GW2 is configured to map the identifier of the serving base station provided by the MS 12 to an address of the serving gateway GW1 in the serving network RAN1, and transmit the handover request to the serving gateway GW1 including an address of the target gateway GW2 to trigger the serving gateway GW1 for context transfer and to forward bearer packets associated with the MS 12 to the target gateway GW2.

In accordance with an embodiment of the present invention, the MS 12 may be also configured to conduct a data session with a serving network element in a serving network. The serving network element may include the serving base station, a mobile management entity, or the serving gateway GW1. The MS 12 may include the transmitting unit 26 configured to transmit a hold message to the serving network element requesting the serving network element to hold the data session and buffer data packets for a predetermined period of time. The transmitting unit 26 may be configured to search for a target network element and obtain an identifier of the target network element. The target network element may include the target base station or the target gateway GW2. The transmitting unit 26 may also be configured to transmit a transmit message to the serving network element requesting to continue the data session and forward the buffered data packets. The MS 12 may perform multiple transmissions of the hold message and transmit message in a time-division multiplexed manner to avoid a transmission delay.

FIG. 3 illustrates a proactive handover between a serving gateway and a target gateway, in accordance with an embodiment of the present invention. At step 100, a mobile station (MS) scans a target network while receiving services from a serving network. The serving network is an access network currently serving the MS. At step 110, the MS obtains an identifier of a target base station associated with the target gateway in the target network. The target network is an access network with which the serving network is to perform handover with. At step 120, the MS transmits the identifier of the target base station as a parameter in a handover request message to a serving base station in the serving network. A person of ordinary skill in the art will appreciate that additional information may be included in the handover request message, such as, but not limited to, an address of the serving base station, the address of the serving gateway, the address of the target base station, and/or the address of the target gateway.

In accordance with an exemplary embodiment of the present invention, the identifier of the target base station in the target network may be transmitted to the serving base station of the serving network as an opaque parameter. An opaque parameter representation may be a parameter in which there is no direct access to parameter fields. For instance, in the opaque parameter, a name of the algorithm associated with the parameter set and some kind of encoding for the parameter set may only be obtained.

At step 130, the serving base station receives and processes the handover request message. In accordance with an exemplary embodiment of the present invention, the serving base station may be configured to have the capability to determine based, for instance, on the target base station identifier or other data included in the handover request message, that the target base station is in another type of network architecture different from the network architecture of the serving base station or the serving base station may treat the handover request message as an opaque block of data. At step 140, the serving base station forwards the handover request message to a control plane entity in the serving gateway. At step 150, the handover request message is processed so that the serving gateway uses the handover request message as a trigger for initiating the handover.

Once the handover is initiated, in accordance with an embodiment of the present invention, at step 160, the serving gateway may be configured to map the address of the target gateway in the target network based on the identifier of the target base station provided in the handover request message. At step 170, the serving gateway triggers context transfer and forwarding of the packets associated with the MS to the target gateway.

FIG. 4 illustrates an alternative proactive handover between a serving gateway and a target gateway, in accordance with an embodiment of the present invention. At step 200, the MS scans a target network while receiving services from the serving network. At step 210, the MS obtains an identifier of the target base station associated with the target gateway in the target network.

In accordance with an embodiment of the present invention, at step 220, the MS is provided with an identifier of the control plane entity of the serving gateway in the serving network. At step 230, the MS sends a layer 2 message as a control plane message to the control plane entity indicating that the MS is performing a handover to the target base station in the target network, where the layer 2 message includes the identifier of the target base station in the target network.

Layer 2 refers to a data link layer of the commonly-referenced multilayered communication model, open systems interconnection (OSI). The Data Link layer is concerned with moving data across the physical links in the network. In a network, the switch is a device that redirects data messages at the layer 2 level, using the destination media access control (MAC) address to determine where to direct the message. The data-link layer may contain two sublayers that are described in the IEEE-802 LAN standards: media access control (MAC) sublayer and logical link control (LLC) sublayer. The data link layer may ensure that an initial connection has been set up, divides output data into data frames, and handles the acknowledgements from a receiver that the data arrived successfully. The data link layer may also ensure that incoming data has been received successfully by analyzing bit patterns at special places in the frames.

At step 240, at the control plane entity in the serving gateway, the MS processes the layer 2 message and initiates the handover for the MS to the target network. At step 250, the control plane entity maps the address of the target gateway in the target network based on the target base station identifier provided in the layer 2 message from the MS. At step 260, the control plane entity a context transfer from to the target gateway and sends a trigger to the serving gateway to initiate forwarding of bearer packets associated with the MS from the serving gateway to the target gateway.

As described in FIGS. 3 and 4, in a proactive handover scenario, the MS performs handover preparation (steps 100-140 in FIG. 3 and steps 200-230 in FIG. 4) prior to executing the handover. In contrast, FIG. 5A and FIG. 5B illustrate a reactive handover between the serving gateway and the target gateway, in accordance with an embodiment of the present invention. For instance, in the method described in FIGS. 5A and 5B, the MS does not do any handover preparation prior to handover. As illustrated in FIG. 5A, at step 300, the MS stores an identifier of the serving base station in the serving network. At step 310, the MS transmits a handover request to the target gateway via the target base station in the target network. At step 320, along with the handover request, the method transmits information including the identifier of the serving base station from the MS to the target gateway in the target network. At step 330, the target network maps the identifier of the serving base station to an address of a serving gateway in the serving network. At step 340, the handover request is transmitted to the serving gateway including an address of the target gateway to trigger the serving gateway for context transfer and to forward bearer packets associated with the MS to the target gateway in the target network. In accordance with an exemplary embodiment of the present invention, the method may transmit from the MS to the target gateway the identifier of the serving base station using a control plane message.

In addition, although the embodiment described in FIG. 5A has been described with respect to a serving gateway, a person of ordinary skill in the art will appreciate that a control plane entity may be similarly implemented to perform the steps previously described with respect to the serving gateway and using the control plane message to transmit the identifier of the serving base station to the target gateway. For instance, as illustrated in FIG. 5B, at step 400, the MS stores an identifier and corresponding address of the control plane entity in the serving network. At step 410, the MS transmits a control plane message to the target gateway via the target base station in the target network. At step 420, the MS transmits the identifier and corresponding address of the control plane entity to the target gateway. At step 430, the target gateway transmits the control plane message indicating handover to the control plane entity including an address of the target gateway to trigger the control plane entity for context transfer and to forward bearer packets associated with the MS to the target gateway.

FIG. 6 illustrates a handover initiated by a network between the serving gateway and the target gateway, in accordance with an embodiment of the present invention. At step 500, the serving base station is configured to include a table, a group, or a list of identifiers of neighboring target base stations in target networks. At step 510, the serving base station sends or transmits a handover command message to the MS including an identifier corresponding to a target base station to which the MS may handover. At step 520, the serving base station sends or transmits a handover trigger message to the serving gateway, such as the control plane entity of the serving gateway, providing the identifier corresponding to the target base station to which the network device has been instructed to perform handover. At step 530, the serving gateway is configured to map an address of the target gateway in the target network based on the identifier corresponding to the target base station. At step 540, the MS receives the handover command message. At step 550, the handover of the MS is performed to the target base station associated with the identifier included in the handover command message. At step 560, the serving gateway performs context transfer and forwarding of bearer packets associated with the MS to the target gateway.

A person of ordinary skill in the art will appreciate that one of the many advantages of the present invention is to provide an apparatus and method enabling triggering handovers at the IP layer optimizing the handovers that occur when the MS moves between different networks. The optimizations in this case may be implemented at the network/IP layer. The triggers for the handover however may be based on either the MS indicating the BSID in a control plane message in the serving or target networks.

It is to be understood that in the embodiment of the present invention, the steps are performed in the sequence and manner as shown although the order of some steps and the like may be changed without departing from the spirit and scope of the present invention. In addition, the steps described in FIGS. 3 to 6 may be repeated as many times as needed.

Accordingly, the various embodiments of the present invention provide, at least, an implementation of a solution providing either a mobile station involvement and/or elements in a radio access network, such as a target base station or a target gateway (i.e., access gateway) that may provide a trigger for handover. Handover signaling messages may need to be enhanced to include an identifier of a target base station in another network, which may be implemented as opaque data and may not require processing at the base station itself. Provisioning of the mapping between an identifier of the target base station to an address of a gateway which serves that target base station may need to be maintained in the serving and target networks.

With respect to the present invention, a mobile station (MS) may be any device that utilizes network data, and can include user equipment, a terminal, a network device, or any other similar type of wireless device. In addition, while the term data has been used in the description of the present invention, the invention has import to many types of network data. For purposes of this invention, the term data includes packet, cell, frame, datagram, bridge protocol data unit packet, packet data and any equivalents thereof.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and step illustrated and described, and accordingly all suitable modifications and equivalents may be resorted to, falling within the scope of the invention.

What is claimed:

1. A network device, comprising:
a scanning unit configured to scan and obtain an identifier associated with a target base station in a target network while receiving services from a serving network; and
a transmitting unit configured to transmit the identifier as a parameter in a handover request message to a serving base station in the serving network, wherein the handover request message is used as a trigger for initiating a handover of the network device from the serving network to the target network.

2. The network device as recited in claim 1, wherein the serving gateway is configured to map an address of a target gateway in the target network based on the identifier in the handover request message and to trigger context transfer and to forward of packets associated with the network device.

3. The network device as recited in claim 1, wherein the identifier of the target base station in the target network is transmitted as an opaque parameter.

4. The network device as recited in claim 1, wherein the serving base station is configured to determine, based on the identifier in the handover request message, whether the target base station is in a network architecture different from the network architecture of the serving base station.

5. The network device as recited in claim 1, wherein the serving base station is configured to determine, based on the identifier in the handover request message, whether the handover request message is to be processed as an opaque block of data.

6. The network device as recited in claim 1, wherein the serving network and the target network are of different network technologies, wherein the network technologies comprise evolution to data optimized, worldwide interoperability for microwave access, or long term evolution.

7. The network device as recited in claim 1, wherein the identifier of the target base station is encoded in the handover request message in a form specific to the serving network and the identifier comprises a target network flag indicating to the serving base station that the target base station belongs to a different access technology from the access technology of the serving base station.

8. A network device, comprising:
scanning means for scanning and obtaining an identifier associated with a target base station in a target network while receiving services from a serving network; and
transmitting means for transmitting the identifier as a parameter in a handover request message to a serving base station in the serving network, wherein the handover request message is used as a trigger for initiating a handover of the network device from the serving network to the target network.

9. A method, comprising:
obtaining an identifier associated with a target base station in a target network while receiving services from a serving network;
transmitting the identifier as a parameter in a handover request message to a serving base station in the serving network; and
using the handover request message as a trigger for initiating a handover of the network device from the serving network to the target network.

10. The method as recited in claim 9, further comprising:
mapping an address of a target gateway in the target network based on the identifier in the handover request message; and
triggering context transfer and forwarding of packets associated with the network device.

11. The method as recited in claim 9, wherein the identifier of the target base station in the target network is transmitted to the serving base station of the serving network as an opaque parameter.

12. The method as recited in claim 9, further comprising:
based on the identifier in the handover request message, determining that the target base station is in a network architecture different from the network architecture of the serving base station.

13. The method as recited in claim 9, further comprising:
based on the identifier in the handover request message, determining that the serving base station is to process the handover request message as an opaque block of data.

14. The method as recited in claim 9, wherein the serving network and the target network are of different network technologies, wherein the network technologies comprise evolution to data optimized, worldwide interoperability for microwave access, or long term evolution.

15. The method as recited in claim 9, further comprising:
encoding the identifier of the target base station in the handover request message in a form specific to the serving network; and
configuring the identifier to comprise a target network flag indicating to the serving base station that the target base station belongs to a different access technology from the access technology of the serving base station.

16. An apparatus, comprising:
a control plane entity in a serving network configured to receive a layer 2 message as a control plane message from a network device indicating that the network device is to perform a handover to a target base station in a target network, wherein the layer 2 message includes an identifier associated with the target base station in the target network, and configured to process the layer 2 message as a trigger to initiate the handover for the network device from the serving network to the target network.

17. A network device, comprising:
a scanning unit configured to scan and obtain an identifier associated with a target base station in a target network;
an identifying unit configured to identify a control plane entity of a serving gateway in a serving network; and
a transmitting unit configured to transmit a layer 2 message as a control plane message to the control plane entity indicating that the network device is performing a handover to the target base station in the target network, wherein the layer 2 message includes the identifier of the target base station and is processed as a trigger to initiate the handover for the network device from the serving network to the target network.

18. The network device as recited in claim 17, wherein the network device is notified of an identity of the control plane entity in the service network.

19. The network device as recited in claim 17, wherein the serving gateway maps an address of a target gateway in the target network based on the identifier of the target base station in the layer 2 message.

20. The network device as recited in claim 17, wherein the control plane entity is further configured to perform a context transfer to the target gateway and configured to send a trigger to the serving gateway to initiate forwarding of bearer packets associated with the network device from the serving gateway to the target gateway.

21. The network device as recited in claim 17, wherein the serving network and the target network are of different network technologies, wherein the network technologies comprise evolution to data optimized, worldwide interoperability for microwave access, or long term evolution.

22. A network device, comprising:
obtaining means for obtaining an identifier associated with a target base station in a target network;
identifying means for identifying a control plane entity of a serving gateway in a serving network; and
transmitting means for transmitting a layer 2 message as a control plane message to the control plane entity indicating that the network device is performing a handover to the target base station in the target network, wherein the layer 2 message includes the identifier of the target base station and is processed as a trigger to initiate the handover for the network device from the serving network to the target network.

23. A method, comprising:
obtaining an identifier associated with a target base station in a target network;
identifying a control plane entity of a serving gateway in a serving network for a network device to communicate;
transmitting a layer 2 message as a control plane message from the network device to the control plane entity indicating that the network device is performing a handover to the target base station in the target network, wherein the layer 2 message includes the identifier of the target base station; and
processing the layer 2 message as a trigger to initiate the handover for the network device from the serving network to the target network.

24. The method as recited in claim 23, further comprising:
mapping an address of a target gateway in the target network based on the identifier of the target base station in the layer 2 message.

25. The method as recited in claim 23, further comprising:
performing a context transfer to the target gateway and
sending a trigger to the serving gateway to initiate forwarding of bearer packets associated with the network device from the serving gateway to the target gateway.

26. The method as recited in claim 23, wherein the serving network and the target network are of different network technologies, wherein the network technologies comprise evolution to data optimized, worldwide interoperability for microwave access (, or long term evolution.

27. A network device, comprising:
a storing unit configured to store an identifier of a serving base station in a serving network; and
a transmitting unit configured to transmit a handover request to a target gateway via a target base station in a target network and configured to transmit the identifier of the serving base station to the target gateway, wherein the target gateway is configured to
map the identifier of the serving base station provided by the network device to an address of a serving gateway in the serving network, and
transmit the handover request to the serving gateway including an address of the target gateway to trigger the serving gateway for context transfer and to forward bearer packets associated with the network device to the target gateway.

28. The network device as recited in claim 27, wherein the network device transmits to the target gateway the identifier of the serving base station using a control plane message.

29. The network device as recited in claim 27, wherein the serving network and the target network are of different network technologies, wherein the network technologies comprise evolution to data optimized, worldwide interoperability for microwave access, or long term evolution.

30. The network device as recited in claim 27, wherein the identifier of the serving base station transmitted to the target gateway is included in the handover request.

31. A network device, comprising:
storing means for storing an identifier of a serving base station in a serving network; and
transmitting means for transmitting a handover request to a target gateway via a target base station in a target network and configured to transmit the identifier of the serving base station to the target gateway, wherein the target gateway maps the identifier of the serving base station provided by the network device to an address of a serving gateway in the serving network, and transmits the handover request to the serving gateway including an address of the target gateway to trigger the serving gateway for context transfer and to forward bearer packets associated with the network device to the target gateway.

32. A method, comprising:
storing an identifier of a serving base station in a serving network;
transmitting a handover request to a target gateway via a target base station in a target network and configured to transmit the identifier of the serving base station to the target gateway;
mapping the identifier of the serving base station provided by a network device to an address of a serving gateway in the serving network; and
transmitting the handover request to the serving gateway including an address of the target gateway to trigger the serving gateway for context transfer and to forward bearer packets associated with the network device to the target gateway.

33. The method as recited in claim 32, further comprising:
transmitting the identifier of the serving base station using a control plane message from the network device to the target gateway.

34. The method as recited in claim 32, wherein the serving network and the target network are of different network technologies, wherein the network technologies comprise evolution to data optimized, worldwide interoperability for microwave access, or long term evolution.

35. The method as recited in claim 32, wherein the identifier of the serving base station transmitted to the target gateway is included in the handover request.

36. A network device, comprising:
a storing unit configured to store an identifier and corresponding address of a control plane entity in a serving network;
a transmitting unit configured to transmit a control plane message to a target gateway via a target base station in a target network, and configured to transmit the identifier and corresponding address of the control plane entity to the target gateway, wherein the target gateway is configured to transmit the control plane message indicating handover to the control plane entity including an address of the target gateway to trigger the control plane entity for context transfer and to forward bearer packets associated with the network device to the target gateway.

37. A method, comprising:
storing an identifier and corresponding address in a network device of a control plane entity in a serving network;
transmitting a control plane message from the network device to a target gateway via a target base station in a target network;
transmitting the identifier and corresponding address of the control plane entity from the network device to the target gateway; and
transmitting the control plane message indicating handover from the target gateway to the control plane entity including an address of the target gateway to trigger the control plane entity for context transfer and to forward bearer packets associated with the network device to the target gateway.

38. The method as recited in claim 37, wherein the serving network and the target network are of different network technologies, wherein the network technologies comprise evolution to data optimized, worldwide interoperability for microwave access, or long term evolution.

39. An apparatus, comprising:
a serving base station in a serving network configured to comprise a list of identifiers of neighboring target base stations in target networks, configured to send a handover command message to a network device including an identifier corresponding to a target base station in a target network to which the network device is to handover, and configured to send a handover trigger message to a serving gateway providing the identifier corresponding to the target base station to which the network device is to handover, wherein
the serving gateway is configured to map an address of a target gateway in the target network based on the identifier corresponding to the target base station,
the network device is configured to receive the handover command message and perform the handover to the target base station associated with the identifier, and
the serving gateway is configured to context transfer and to forward bearer packets associated with the network device to the target gateway.

40. The apparatus as recited in claim 39, wherein the serving network and the target network are of different network technologies, wherein the network technologies comprise evolution to data optimized, worldwide interoperability for microwave access, or long term evolution.

41. An apparatus, comprising:
serving base station means, comprising a list of identifiers of neighboring target base stations in target networks, for sending a handover command message to a network device including an identifier corresponding to a target base station in a target network to which the network device is to handover, and for sending a handover trigger message to a serving gateway providing the identifier corresponding to the target base station to which the network device is to handover, wherein
the serving gateway maps an address of a target gateway in the target network based on the identifier corresponding to the target base station,
the network device receives the handover command message and perform the handover to the target base station associated with the identifier, and
the serving gateway context transfers and forwards bearer packets associated with the network device to the target gateway.

42. A method, comprising:
configuring a serving base station in a serving network to include a list of identifiers of neighboring target base stations in target networks;
sending, through the serving base station, a handover command message to a network device including an identifier corresponding to a target base station in a target network to which the network device is to handover;
sending, through the serving base station, a handover trigger message to a serving gateway providing the identifier corresponding to the target base station to which the network device is to handover;
configuring the serving gateway to map an address of a target gateway in the target network based on the identifier corresponding to the target base station;
receiving the handover command message at the network device;
performing the handover of the network device to the target base station associated with the identifier; and
performing at the serving gateway context transfer and forwarding of bearer packets associated with the network device to the target gateway.

43. The method as recited in claim 42, wherein the serving network and the target network are of different network technologies, wherein the network technologies comprise evolution to data optimized, worldwide interoperability for microwave access, or long term evolution.

44. A network device configured to conduct a data session with a serving network element in a serving network, comprising:
a transmitting unit configured to transmit a hold message to the serving network element requesting the serving network element to hold the data session and buffer data packets for a predetermined period of time, configured to search for a target network element and obtain an identifier of the target network element, and configured to transmit a transmit message to the serving network element requesting to continue the data session and forward the buffered data packets, wherein the network device performs multiple transmissions of the hold message and transmit message in a time-division multiplexed manner to avoid a transmission delay.

45. The network device as recited in claim 44, wherein the serving network element comprises a serving base station, a mobile management entity, or a serving gateway.

46. The network device as recited in claim 44, wherein the target network element comprises a target base station or a target gateway.

47. A method, comprising:
conducting a data session with a serving network element between a network device and a serving network;
transmitting a hold message to the serving network element requesting the serving network element to hold the data session and buffer data packets for a predetermined period of time;
searching for a target network element and obtain an identifier of the target network element;
transmitting a transmit message to the serving network element requesting to continue the data session and forward the buffered data packets; and
performing multiple transmissions by the network device of the hold message and transmit message in a time-division multiplexed manner to avoid a transmission delay.

48. The method as recited in claim 47, further comprising:
configuring the serving network element to comprise a serving base station, a mobile management entity, or a serving gateway.

49. The method as recited in claim 47, further comprising:
configuring the target network element to comprise a target base station or a target gateway.
